(19) United States
(12) Patent Application Publication
(10) Pub. No.: US 2020/0293271 A1
(43) Pub. Date: Sep. 17, 2020

(54) GENERATING AND INCORPORATING INTERACTIVE AUDIO CONTENT FOR VIRTUAL EVENTS

(71) Applicant: Fayble, LLC, Oakland, CA (US)

(72) Inventors: Alan S. Moskowitz, Oakland, CA (US); Bidit Acharya, Oakland, CA (US); Matthew Benjamin Naranjo, Morgan Hill, CA (US); Susan Elizabeth Wilson, San Diego, CA (US)

(73) Assignee: Fayble, LLC, Oakland, CA (US)

(21) Appl. No.: 16/817,356

(22) Filed: Mar. 12, 2020

Related U.S. Application Data
(60) Provisional application No. 62/817,369, filed on Mar. 12, 2019.

(51) Int. Cl. G06F 3/16

(52) U.S. Cl. CPC G06F 3/165

(57) ABSTRACT

Provided are methods and systems for generating interactive audio content for virtual events. The interactive audio component is generated at least based on input provided by users (e.g., listeners) and/or other parties (e.g., sponsors) associated with a virtual event. Other information may also be used for generating the interactive audio component. The interactive audio component is not broadcasted but rather combined with non-interactive audio content, which is separately generated, e.g., using data segments selected for the virtual event and announcer's commentary. The combined audio content is referred to interactive audio content and is delivered to users (e.g., via radio transmission and/or internet streaming) thereby enhancing users' perception of the virtual even in comparison to the non-interactive audio content alone. The interactive audio content may be delivered to a selected subset of users (e.g., users, who provided the input), while other users receive the non-interactive audio content.

### CROSS-REFERENCE TO RELATED APPLICATIONS

This application claims priority under 35 U.S.C. § 119(e) to U.S. Provisional Application No. 62/817,369, filed Mar. 12, 2019, entitled GENERTING AND INCORPORATING INTERACTIVE AUDIO CONTENT FOR VIRTUAL EVENTS, the contents of which are hereby incorporated by reference.

### TECHNICAL FIELD

The present disclosure relates to a system and associated methods of audio and video content processing. In one example, the present disclosure relates to generation of virtual sporting events.

### BACKGROUND

Listening to an audio broadcast of an event, such as a sport event, a political debate, or a musical performance, can be exciting. Yet, many listeners would prefer to attend a live event, given the opportunity. One important aspect of a live event, in comparison to an audio broadcast, is being surrounded by other people attending the event and experiencing the crowd as well as contributing to the crowd (e.g., by cheering, clapping, discussing the event with people nearby). While traditional methods of transmitting audio broadcast over the radio do not provide much opportunity to “participate” and “contribute” to the event like actual attendees of the liver event, various approaches are being developed capable of interacting with the event. For example, a listener can call to the radio station and then, if the telephone conversation is being broadcasted, listen to his/her voice over the radio. However, such methods are typically, cumbersome to all parties involved and not easily applicable to some types of broadcasts.

What is needed are methods and systems for generating interactive audio content for virtual events.

### SUMMARY

The following presents a simplified summary of the disclosure in order to provide a basic understanding of certain embodiments of this disclosure. This summary is not an extensive overview of the disclosure, and it does not identify key and critical elements of the present disclosure or delineate the scope of the present disclosure. Its sole purpose is to present some concepts disclosed herein in a simplified form as a prelude to the more detailed description that is presented later.

Provided are methods and systems for generating interactive audio content for virtual events. The interactive audio component is generated at least based on input provided by users (e.g., listeners) and/or other parties (e.g., sponsors) associated with a virtual event. Other information may also be used for generating the interactive audio component. The interactive audio component is not broadcasted but rather combined with non-interactive audio content, which is separately generated, e.g., using data segments selected for the virtual event and announcer's commentary. The combined audio content is referred to as interactive audio content and is delivered to users (e.g., via radio transmission and/or Internet streaming) thereby enhancing users' perception of the virtual event in comparison to the non-interactive audio content alone. The interactive audio content may be delivered to a selected subset of users (e.g., users, who provided the input), while other users receive the non-interactive audio content.

In one aspect, which may include at least a portion of the subject matter of any of the preceding and/or following examples and aspects, a method for generating interactive audio content for a virtual event comprises receiving, at interactive audio module, user input from first set of user devices. The method further comprises generating, at the interactive audio module, an interactive audio component based on at least the user input, and delivering the interactive audio component 182 to an audio content integration module. The method further comprises receiving, at the audio content integration module, non-interactive audio content from an audio creation module. The non-interactive audio content is an audio representation of the virtual event 101 at a set time. The method further comprises combining, at the audio content integration module, the non-interactive audio content and the interactive audio component, thereby generating the interactive audio content. The method further comprises transmitting, by the audio content integration module, the interactive audio content to a delivery module.

The non-interactive audio content may have a first sound level, the interactive audio component may have a second sound level, and the interactive audio content may be generated based on the first sound level of the non-interactive audio content and the second sound level of the interactive audio component.

The user input may comprise a user count corresponding to the first set of user devices, the interactive audio component may be a crowd sound, and the first sound level may be proportional to the user count. The user input may comprise a user audio content, and generating the interactive audio component may comprise selecting at least a portion of the user audio content in the user input.

The user input may comprise one or more social media posts associated with the virtual event, and the interactive audio component may be generated based on content of one or more social media posts in the user input. Generating the interactive audio component may comprise generating an audio representation of the one or more social media posts in the user input.

The user input may comprise a commercial transaction completed by the first set of user devices and associated with the virtual event.

The method may further comprise receiving, at the interactive audio module, additional user input from a second set of user devices, wherein the interactive audio component is generated based on the user input and the additional user input. The interactive audio content may be transmitted to the first set of user devices and the second set of user devices.

The method may further comprise receiving, at the interactive audio module, additional user input from a second set of user devices. The method may further comprise generating, at the interactive audio module, additional interactive audio component based on at least the additional user input. The method may further comprise combining, at the audio content integration module, the non-interactive audio content and the additional interactive audio component, thereby generating additional interactive audio content, wherein the additional interactive audio content is different from the interactive audio content. The method may further comprise transmitting, by the audio content integration module, the additional interactive audio content to the delivery module. The interactive audio content and the additional interactive audio content may be transmitted to different user devices.

The method may further comprise retrieving, from a user database, user related data associated with the first set of user devices. The interactive audio component may be generated based on the user input and the user related data retrieved from the user database. The user related data may comprise one or more of: team choice, commercial transactions, and identification of a second set of user devices.

The method may further comprise retrieving, from an event database, event related data associated with the set time in the virtual event, wherein the interactive audio component is generated based on the user input and the event related data.

The method may further comprise transmitting, by the delivery module, the interactive audio content to the first set of user devices. The method may further comprise transmitting, by the delivery module, the interactive audio content to a second set of user devices, different from first set of user devices. The method may further comprise transmitting, by the delivery module, the non-interactive audio content to a third set of user devices, different from first set of user devices and the second set of user devices.

The virtual event may be a virtual sporting event. The virtual event may be a virtual football game.

Other implementations of this disclosure include corresponding devices, systems, and computer programs, and associated methods for generating interactive audio content for a virtual event. These other implementations may each optionally include one or more of the following features. For instance, provided is a non-transitory computer readable medium storing one or more programs for execution by a computer. The one or more programs comprise instructions for implementing the described method.

Also provided is a system for generating interactive audio content for a virtual event. The system comprises an interactive audio module configured to receive user input from a first set of user devices, and generate an interactive audio component based on at least the user input. The system further comprises an audio content integration module configured to receive the interactive audio component from the interactive audio module, and receive non-interactive audio content, the non-interactive audio content comprising an audio representation of the virtual event at a set time. The audio content integration module is further configured to combine the non-interactive audio content and the interactive audio component, thereby generating interactive audio content, and transmit the interactive audio content.

server system configured to generate a virtual sporting event, which comprises one or more processors, memory, and one or more programs stored in the memory. The one or programs comprise instructions for implementing the described method.

These and other examples are described further below with reference to figures.

### BRIEF DESCRIPTION OF THE DRAWINGS

FIG. 1A is a schematic illustration of a system for generating virtual events, in accordance with some examples,

FIG. 1B is a schematic illustration of a portion of the system in FIG. 1A, used for generating interactive audio content for the virtual events, in accordance with some examples.

FIG. 2A is a process flowchart of a method for generating interactive audio content for a virtual event, in accordance with some examples.

FIGS. 2B, 2C, and 2D are block diagrams schematically illustrating different examples of interactive audio contents as well as components of these interactive audio contents.

FIGS. 3A, 3B, and 3C are flowcharts illustrating different delivery examples of interactive audio content for the same virtual event.

FIG. 4 illustrates a particular example of a computer system that can be used with various embodiments of the present disclosure.

FIG. 5 is an example user interface for displaying a video component of a virtual sporting event, in accordance with one or more embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting. On the contrary, it is intended to cover alternatives, modifications, and equivalents as may be included within the spirit and scope of the present disclosure as defined by the appended claims.

### INTRODUCTION

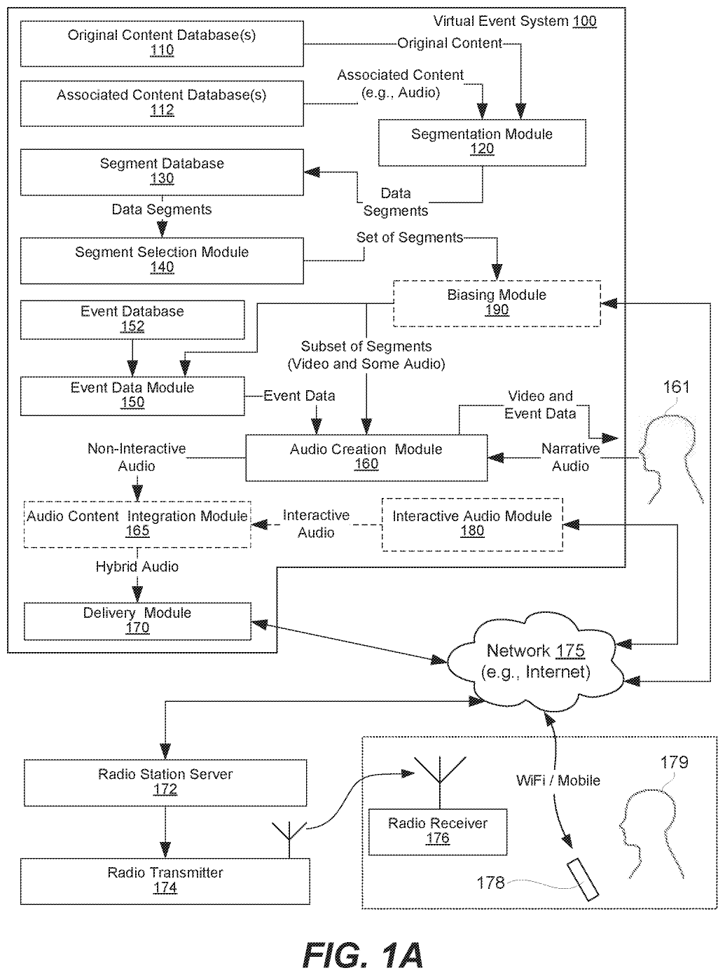

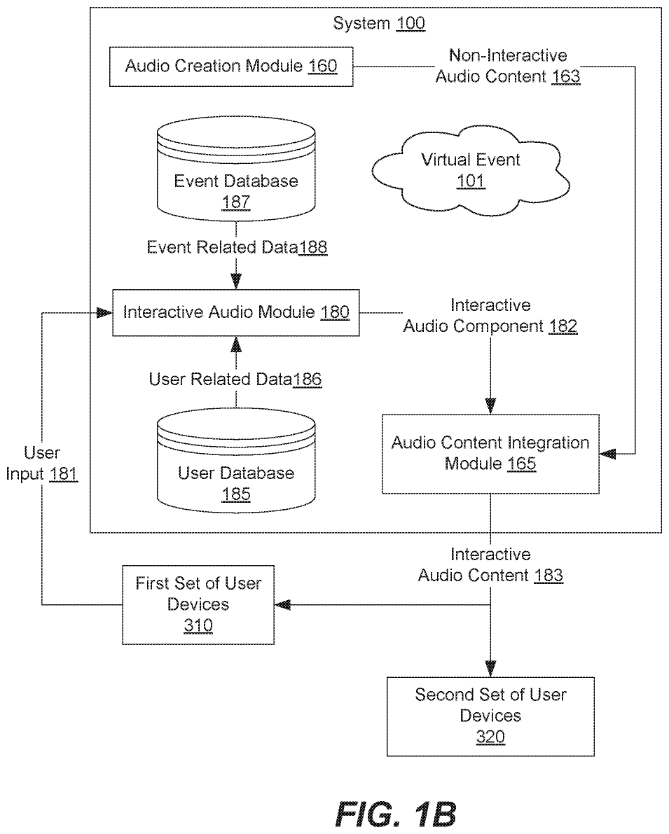

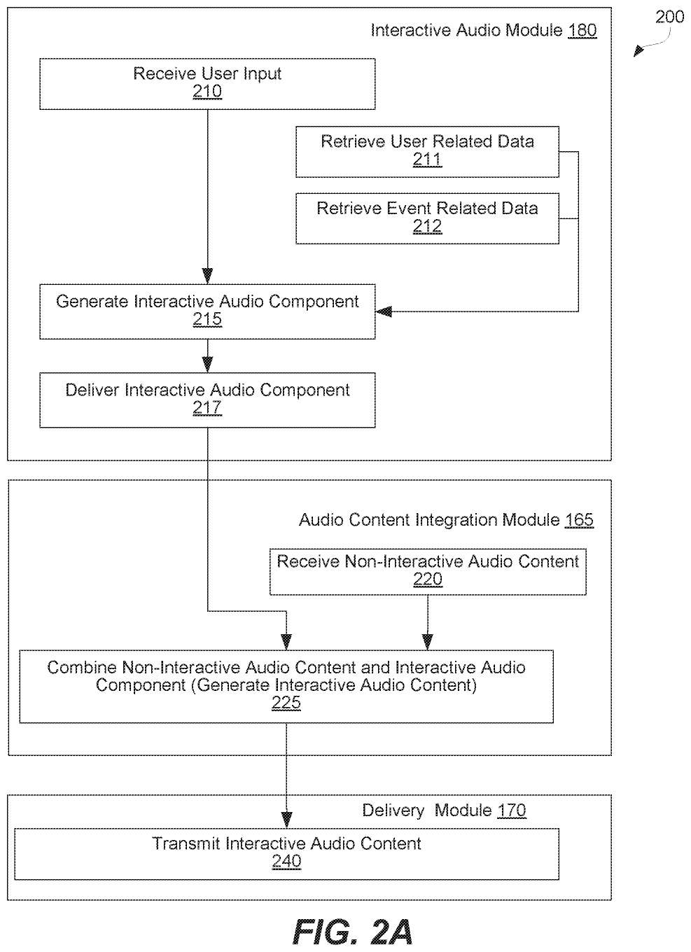

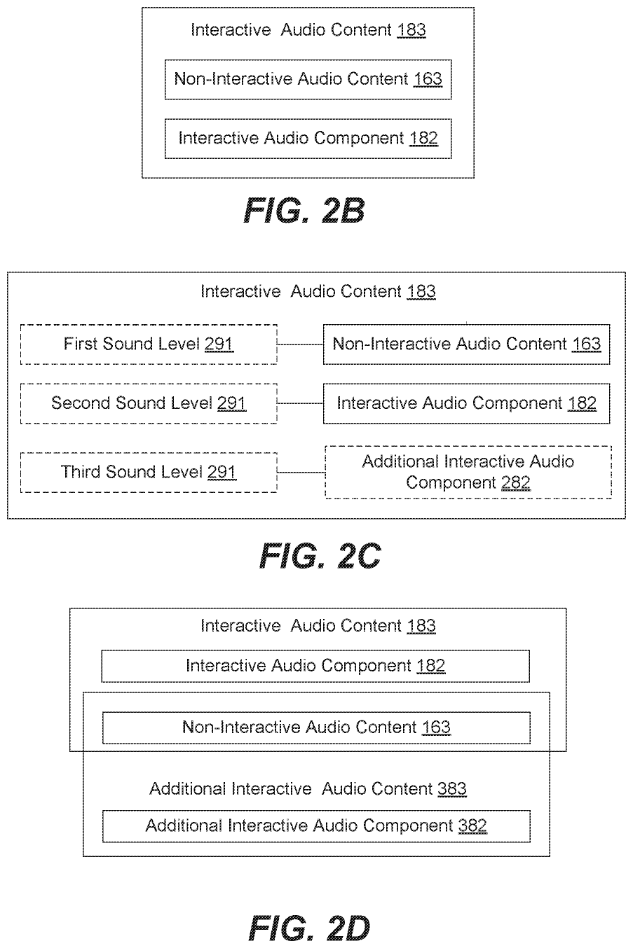

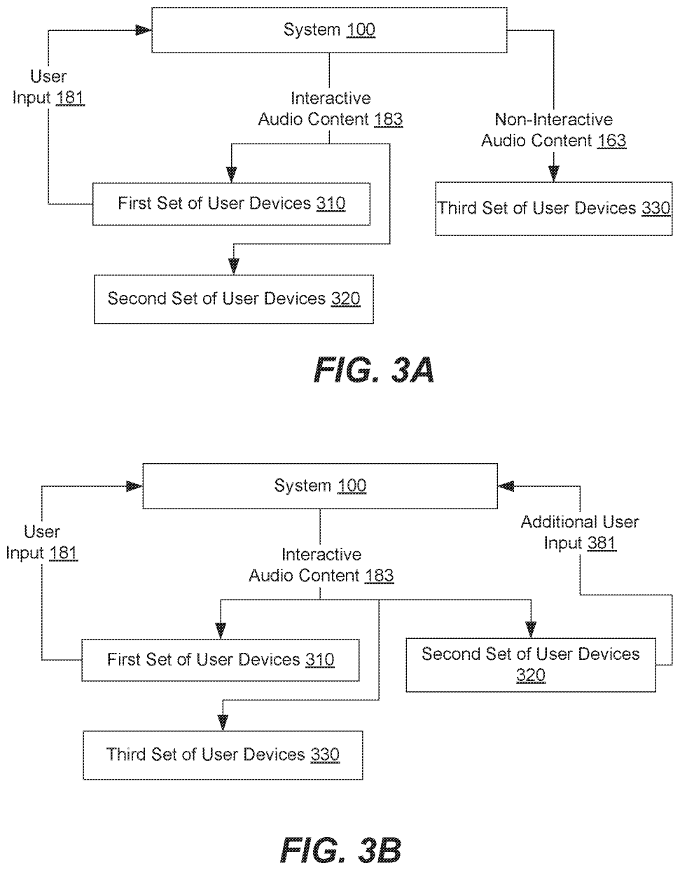

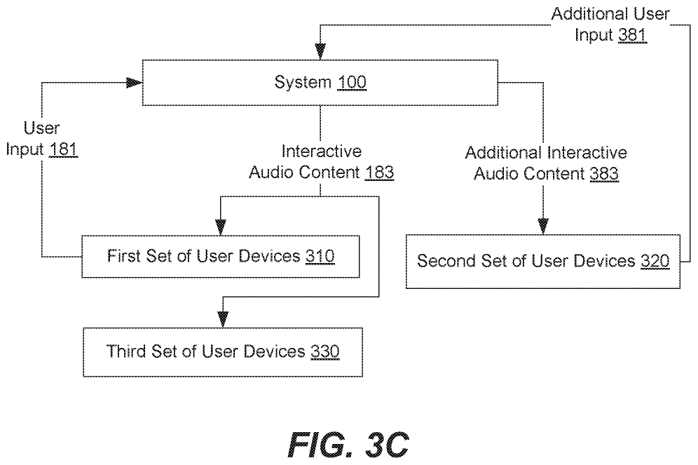

Interactive audio enhances the experience of listening to a broadcast of an event, creating perception of the actual presence at the event or at least active participation in the event by the listener. The importance of interactive audio is even greater when a broadcasted event is a virtual event, which does not occur in real life and is artificially created. For example, a broadcast of a virtual football game may be created by selecting a sequence of plays and generating a narration of these plays. Various aspects of methods and systems for generating such virtual events are described below with reference to FIG. 1A. Interactive audio represents specific aspects of this overall process and further explored with reference to FIGS. 1B and 2A-D. Finally, the distribution of interactive audio is described with reference to FIGS. 3A-3C.

The interactive audio process starts with generating an interactive audio component, using at least some form of user input, such as voice input (e.g., cheer), text input (e.g., social media post), transaction (e.g., purchase, bid, or donation), and the like. In some examples, various user data, associated with the devices providing the user input, and/or virtual event data is also used for generating the interactive audio component. The user input is received from one or more user devices. In some examples, these user devices also receive the event broadcast (e.g., streaming, radio broadcast).

The interactive audio component is only a part of the interactive audio content, which is generated using the interactive audio component, e.g., by combining the interactive audio component with a non-interactive audio content. As such, the interactive audio component may not be delivered or broadcasted to the users (as a standalone component) but instead delivered as a part of the interactive audio content.

In other words, the interactive audio content is a combination of the interactive audio component and the non-interactive audio content. The interactive audio content is then delivered to all user devices (e.g., as a part of the radio broadcast) or at least a subset of user devices (e.g., using user-specific streaming). For examples, user devices that have provided the user input earlier and/or related devices receive the interactive audio content. In some examples, the non-interactive audio content is also delivered to other user devices. For example, the interactive audio component of the interactive audio content may not be relevant or interesting to some users (e.g., listeners of the virtual event) and these users receive the non-interactive audio content. As such, some user devices may receive the non-interactive audio content, while other user devices may receive interactive audio content at the same time. Alternatively, all user devices receive the interactive audio content (e.g., via streaming, radio broadcast).

Selectively adding one or more interactive audio components to the broadcast of a virtual event improves user experience and makes the virtual event more interactive, enjoyable, and realistic. The interactive audio components may be specifically selected to create an event immersion effect, i.e., as if listeners are actually present at the event even though it is not possible due to the virtual nature of the event. Specifically, listeners are able to feel the effects of their actions and actions of other listeners, provided as user inputs on their devices. It should be noted that because broadcasts of virtual events are delivered in the audio form, the terms “users” and “listeners” are interchangeable.

The following examples can help with illustrating various interactive audio aspects. In one example, a user cheers into a user device (e.g., the microphone of a cell phone), which then transmits this cheer in the form of the user input to the virtual event system. In a more specific example, the content of the cheer (e.g., the name of the team), the sound level, the timing of the cheer, the geographic location of the user device, and/or the user identity may also form the user input and may be used to generate an interactive audio component. In this example, the interactive audio component may be an increased level of the crowd sound. The increased level may be determined based on the sound level of the cheer received from the user and/or based on the number of cheers received from all cheering users at that time. Either a standard crowd sound may be used (with an adjusted volume level) or a newly generated crowd sound (combining several cheers from the user inputs) may be used. In some example, the selection of cheers from the user inputs is performed based on relationship between user devices (e.g., previously forming a cheering group, same geographic location, any other common factor).

In another example, the user input is provided as a text data, e.g., as a social medial post (e.g., tweet), short service message (SMS), phone call/dial in, and/or e-mail. The text data is converted into an audio representation (e.g., cheer, announcement, etc.) and added as an interactive audio component to the non-interactive audio content.

Yet another user input example includes a transaction, performed in the context of the virtual event, e.g., a purchase, wager, donation, e-commerce. Some characteristics of this transaction, e.g., amount spent or waged, may be used to control fan excitement (e.g., the sound level of a cheer).

In another example, the user input may be a simple press of a button/user interface area in response to an announcement made during the virtual event, e.g., “Are there any fans of this team?” The number of these user inputs is used to control the cheer sound level and other aspects of the audio broadcast.

### Virtual Event System Examples

In some examples, system 100 for generating interactive audio content for virtual event 101 is the same as or a part of a system that also generates virtual event 101 and non-interactive audio content 163 representing virtual event 101. The overall system is schematically presented in FIG. 1A.

In some embodiments, virtual event system 100 comprises original content database 110, associated content database 112, segmentation module 120, segment database 130, segment selection module 140, event data module 150, event database 152, audio creation module 160, audio content integration module 165, delivery module 170, and interactive audio module 180. Each module may be implemented as a separate server system or configured as a single server system in virtual event system 100 that is configured to perform the operations of all modules. Similarly, each database of virtual event system 100 may be implemented as a separate database or configured as a single database system that is configured to perform the operations of all databases.

In some examples, segmentation module 120 is used for segmenting original content data, which may be received from original content database 110. Some examples of the original content include audio and video content data, associated with original events, such as original sporting events (e.g., American football, soccer, baseball, basketball, hockey, tennis, golf, etc.). Such original content data may be content associated with live or recorded coverage of an original sporting event that is broadcast over television, radio, or other broadcasting media, such as the internet. Virtual event 101 is modeled based on these original events.

The original content may correspond with associated content provided in associated content database 112, e.g., based on various time positions or other chronological measurement. Some examples of the associated content are various other footage of the sporting event, sounds from the field, player sounds, audience sounds, sounds from game officials or referees, commentary from a sports announcer or sportscaster, etc. Associated content may further include statistical play data corresponding to the original sporting event.

In some examples, segmentation module 120 is used to separate the original content and associated content, into event segments based on predetermined milestones (e.g., down in a football game, at bat in a baseball game, clock time in a basketball game). Various techniques may be implemented to identify the predetermined milestones, such as optical character recognition (OCR) of information shown within the video of the original content, statistical play data, motion detection, audio recognition of various audio and sounds in the original content.

In some examples, segmentation module 120 also identifies event segments by marking the beginning and end of each event segment based on the identified milestones. Specifically, the time position at which a milestone occurs may be recorded as a mark-in point corresponding to the beginning of an event segment. Additionally, or alternatively, the time position at which a milestone occurs may be recorded as a mark-out point corresponding to the end of an event segment.

Segment selection module 140 is configured to select one or more event segments for each time segment of virtual event 101. For example, virtual event 101 comprises multiple consecutive time segments, which may vary in length of time and may be associated with one or more event segments. In some embodiments, the length of each time segment may correspond to the length of the one or more associated event segments, selected by segment selection module 140 for such time segment. Specifically, a set of valid event segments for each time segment is identified based on event-specific constraints, such as time position in virtual event 101, location position (e.g., field position of the ball in a football game), or some other factors (e.g., the number of outs in an inning in a baseball game).

One or more valid event segments may then be selected for the time segment based on a combination of one or more different segment selection algorithms at operation 404. For example, a valid event segment may be randomly selected for the time position. However, other segment selection algorithms may be implemented. Various segment selection algorithms and methods may include a Virtual Coach algorithm, a Virtual Team algorithm, a Principled Play algorithm, an Interactive Play algorithm, and an Exhaustive Play algorithm.

Various systems and methods for segment selection for generation of a virtual event are described in U.S. patent application Ser. No. ______ (Attorney Docket No. FAYBP001US) by Moskowitz et al., filed on ______, titled SYSTEMS AND METHODS FOR GENERATION OF VIRTUAL SPORTING EVENTS, which is incorporated by reference herein in its entirety and for all purposes.

One or more of the segment selection algorithms may utilize machine learning techniques or neural networks to determine probabilities of occurrence for various types of plays at various field positions and other progress points of a sporting event. Once event segments have been selected for each time segment of virtual event 101, the selected event segments are transmitted to event data module 150. In some embodiments, information corresponding to the selected event segments (e.g., segment identification or classification) is also transmitted to event data module 150.

Event database 152 may store various virtual audio corresponding to various types of virtual events 101 (e.g., sporting events). Such virtual audio may be artificially created or recorded elsewhere. However, in some embodiments, the virtual audio may be unrelated to the plays or events included in the event segments, to which they are mapped. For example, virtual audio for a football game may include an audible or dialogue between players, contact or hitting sounds, whistles, etc. Event data module 150 may select virtual audio for a particular event segment based on the characteristics of the original audio in the original content or associated content.

In some examples, event database 252 may also store fictional character information including information about fictional players, coaches, teams, officials. For example, fictional character information may include biographies and historical statistics. In some embodiments, fictional character information may be based in whole, or in part, on existing or actual historical individuals, such as players, coaches, and teams of that sport. For example, two fictional teams may be selected for a virtual football game.

In some examples, event data module 150 may further aggregate the virtual event data to derive virtual game statistics or virtual statistical play data. For example, the cumulative clock time of the virtual sporting event may be calculated. Event data module 150 may take into account various situations in a sporting event such as timeouts, pauses, or breaks. As another example, scoring plays may be tallied at each time segment to determine the score at any given time position of the virtual sporting event. As another example, penalties may be determined and tracked such that penalty consequences for penalty violations for particular sports may be implemented in the virtual sporting event. For example, if a particular fictional player is ejected based on a penalty violation, that fictional player will be replaced by another fictional player from fictional character information. In some embodiments, such virtual game statistics may be transmitted to segment selection module 140 to affect the selection of event segments. For example, if a player in a hockey match is placed in a penalty box, the segment selection module may only select event segments where a particular team plays shorthanded.

A video component of the virtual event is generated from the selected event segments at audio creation module 160. Audio creation module 160 may be configured to integrate the selected event segments and mapped virtual event data into a video component of the virtual sporting event. In various embodiments, the segment selection information may be transmitted to audio creation module 160 which may retrieve the selected segments from the original content stored in original content database 110. As such, the video segments of the identified segment may be transmitted to the audio creation module. Audio creation module 160 may be configured to extract only the identified video segments corresponding to the selected event segments. However, in some embodiments, the audio segments of the identified event segments may also be received at audio creation module 160, such as in file formats where audio and video data are combined.

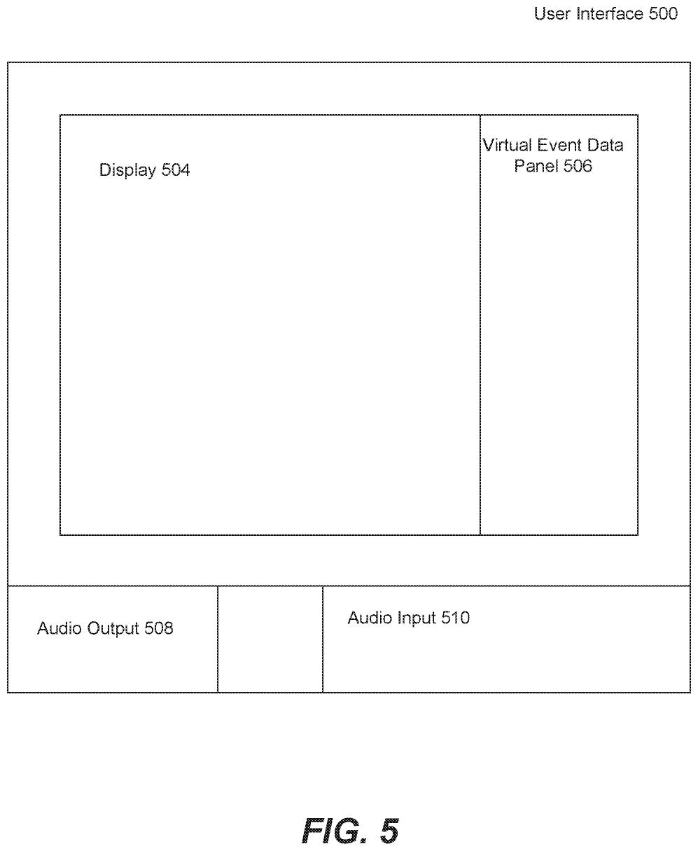

Non-interactive audio content, which may be also referred to as a non-interactive audio component is generated at audio creation module 160 based on the generated video component. In certain embodiments, the video component of the virtual sporting event may be displayed at a user interface for viewing by announcer 161 and/or other users. With reference to FIG. 5, shown is an example user interface 500 for displaying a virtual sporting event, in accordance with one or more embodiments. In various embodiments, user interface 500 is communicatively coupled to audio creation module 160. In some embodiments, user interface 500 may be an integrated component of audio creation module 160.

The video component may be displayed at display 504 including the virtual event data such as the virtual sounds, fictional character information, and accumulated scoring and other virtual game statistics. The fictional character information and virtual game statistics may be displayed on the user interface at panel 506. In various embodiments, panel 506 may be a graphical information panel or overlay on the video component, for example. However, in some embodiments, panel 506 may be a separate window on display 504. In yet other embodiments, panel 506 may be another display separate from display 504. Virtual audio sounds may be presented via audio output device 508. In some embodiments, the video component is displayed without desensitization, along with corresponding original audio segments from the corresponding selected event segments.

Announcer 161 may then record narrative audio into an audio input device 510 based on the video component and virtual event data. The narrative audio may comprise commentary, analysis, or other dialogue pertaining to the virtual sporting event and associated virtual even data. The recorded narrative audio may then be combined with the virtual audio and sounds mapped to the selected event segments (e.g., crowd cheer, helmet hits) to generate non-interactive audio content 163 of virtual event 101. In some embodiments, non-interactive audio may refer to audio component comprising audio selected and created entirely by virtual event system 200 and excluding audio from external sources, such as client devices.

In some embodiments, the narrative audio may also comprise advertisements or other information from sponsors. Alternatively, such advertisements and other like information may be presented as separate audio data (e.g., prerecorded information), incorporated into non-interactive audio content. In some embodiments, the commentary may also be automatically generated by a computer system which provides speech and dialogue based on the virtual event data. For example, a computing system may generate a script based on the mapped virtual event data and implement text-to-speech programs to read the script.

In some embodiments, the non-interactive audio may be transmitted via delivery module 170, which may include a database for storing audio components for one or more virtual events. Delivery module 170 may be configured to transmit the audio component (non-interactive or interactive, as further described below) as an audio file to a network, such as network 175, e.g., Internet.

In some embodiments, the audio component is transmitted to user device 178 over Wi-Fi or mobile data. In some embodiments, the audio component is transmitted radio station server 172 for broadcast via radio transmitter 174. The radio broadcast may then be received by radio receiver 176 and output to user 179. In some examples, radio receiver 176 may be a component of user device 178.

A portion of system 100 responsible for generating interactive audio content for virtual event 101 will now be described with reference to FIG. 1B. Specifically, system 100 comprises interactive audio module 180 and audio content integration module 165. Interactive audio module 180 is configured to receive user input 181 from first set of user devices 310. User device 178, shown in FIG. 1A and described above, may be a part of first set of user devices 310 supplying user input 181 to interactive audio module 180. User input 181 may take various forms such as audio (e.g., cheer generated by users and captured by microphones of first set of user devices 310), text (e.g., social media posts generated by first set of user devices 310), confirmation (e.g., users pressing a button screen portions on the UI of first set of user devices 310 to indicate certain response), geographic location of first set of user devices 310, user data associated with first set of user devices 310, and the like. Additional examples of user input 181 are described below with reference to method 200 for generating interactive audio content 183 and FIG. 2A.

Interactive audio module 180 may be a standalone computer system or integrated into a computer system together with other modules of system 100. This computer system is equipped with a communication device (e.g., modem), configured to form a communication link with first set of user devices 310 and receive user input 181 from first set of user devices 310 over network 175. In some examples, interactive audio module 180 receives user input 181 directly from the first set of user devices 310. Alternatively, user input 181 is received by interactive audio module 180 through delivery module 170 of overall system 100.

Interactive audio module 180 may also be configured to generate interactive audio component 182 based on at least user input 181. Various aspects of this operation are described below with reference to method 200 for generating interactive audio content 183 and FIG. 2A. Interactive audio module 180 may be equipped with a processor for performing this operation.

Interactive audio module 180 is also configured to deliver interactive audio component 182, e.g., to audio content integration module 165. In some examples, interactive audio module 180 and audio content integration module 165 are integrated into the same hardware and/or software. Alternatively, interactive audio module 180 and audio content integration module 165 are standalone components.

As noted above, system 100 also comprises audio content integration module 165, configured to receive interactive audio component 182 (from interactive audio module 180) and receiving non-interactive audio content 163 (from audio creation module 160). Non-interactive audio content 163 is an audio representation of virtual event 101 at a set time. In some examples, non-interactive audio content 163 is continuously received by audio content integration module 165 as virtual event 101 progresses. While the entire duration of virtual event 101 has non-interactive audio content 163, certain periods of virtual event 101 may not have any corresponding interactive audio component 182. In other words, interactive audio component 182 may be intermittent, while non-interactive audio content 163 is continuous.

Audio content integration module 165 is configured to combine non-interactive audio content 163 and interactive audio component 182 thereby generating interactive audio content 183. Various aspects of this operation are described below with reference to method 200 for generating interactive audio content 183 and FIG. 2A, Furthermore, audio content integration module 165 is configured transmit interactive audio content 183.

In some examples, system 100 also comprises event database 187, which stores various event related data 188 associated with virtual event 101, e.g., crowd sounds, cheers. This data may be used while generating interactive audio component 182 as further described below. In some examples, event database 187 is the same as associated content database 112, described above with reference to FIG. 1A.

In some examples, system 100 also comprises user database 185, which stores various user related data 186, e.g., user's favorite teams, users' favorite players, users' groups, and the likes. This data may be used while generating interactive audio component 182 as further described below.

### Examples of Methods for Generating Interactive Audio Content for Virtual Events

FIG. 2A is a process flowchart corresponding to method 200 for generating interactive audio content 183 for virtual event 101. Method 200 is performed using system 100, various examples of which are described above and below. Key components of system 100 involved in various operations of method 200 are interactive audio module 180 and audio content integration module 165. Some examples of virtual event 101 include, but are not limited to, a virtual sporting event, such as a virtual football game. Specifically, various operations and features of method 200 will be described below in the context of a virtual sporting event. However, one having ordinary skill in the art would understand that these operations and features are applicable to other types of virtual events.

Method 200 comprises receiving (block 210) user input 181 from first set of user devices 310. Specifically, user input 181 is received at interactive audio module 180. User input 181 may include various characteristics of first set of user devices 310, such as a user count (e.g., a number of user devices in the first set), geographic location of each device, device types (e.g., phone, computer), device identifiers (e.g., internet protocol (IP) address, system login). First set of user devices 310 may include one or more devices, communicatively coupled to system 100 via network 175. As further described below, first set of user devices 310 may also be used for receiving interactive audio content 183 from system 100 and delivering interactive audio content 183 to their users, e.g., generating the actual sound corresponding to interactive audio content 183. As such, these devices are configured to form communication connections (e.g., Internet connection) with system 100, receive input from their users (e.g., audio input via microphones, user interface (UI) interaction, transactions (purchases, wagers), and the like), receive interactive audio content 183 from system 100, and generate the actual sound corresponding to interactive audio content 183. Some examples of such devices include, but are not limited to, smartphones, computers, and the like.

First set of user devices 310 should be distinguished from other types of devices, which do not provide any user input to system 100. For example, FIG. 3A illustrates second set of user devices 320, which also receives interactive audio content 183, even though no user input is provide by second set of user devices 320. Second set of user devices 320 may be similar to first set of user devices 310, e.g., also operable to provide user input (e.g., a different time during virtual event 101). Second set of user devices 320 may be specifically selected based on various characteristics of interactive audio content 183. In some examples, the users of first set of user devices 310 and the users of second set of user devices 320 may be fans of the same virtual team, while interactive audio content 183 may include the cheer for this virtual team.

Furthermore, FIG. 3A illustrates third set of user devices 330, which receives non-interactive audio content 163, different from interactive audio content 183. Unlike specific selection of devices for receiving interactive audio content 183, non-interactive audio content 163 may be broadcasted generally, e.g., via radio transmission or general streaming or podcast. As such, system 100 may not request any information about third set of user devices 330. One example of such devices is radio receivers (including conventional AM-radios, FM-radios, satellite radios, and the like). However, smartphones and computers can also be used for receiving and delivering non-interactive audio content 163. Alternatively, all user devices receive interactive audio content 183.

As noted above, one example of user input 181 is a transaction or, more specifically, a commercial transaction completed by first set of user devices 310 and associated with virtual event 101. For example, a virtual team may have a sponsor, which designates a specific time interval during and/or before virtual event for transactions. These transactions may be performed by first set of user devices 310 and accounted either by first set of user devices 310 or another system, e.g., a sponsor server, and provided interactive audio module 180 in the form of user input 181. Fans may be interested in supporting their team and completing these transactions, which are later reflected in interactive audio component 182 as a team cheer, specific acknowledgments of users, and the like.

Method 200 further comprises generating (block 215) interactive audio component 182 based on at least user input 181. Specifically, interactive audio component 182 is generated by interactive audio module 180. This operation may depend, in part, on the type of user input 181 received. For example, when user input 181 is audio input, interactive audio component 182 may be generated by selecting at least a portion of this input. When user input 181 comprises multiple different audio inputs, e.g., received from multiple user devices in first set of user devices 310, interactive audio component 182 may be generated by combining these audio inputs or selecting a subset of these inputs. In some examples, user input 181 is a text input (e.g., a social media post). In these examples, the text input is converted into a corresponding audio.

In some examples, method 200 further comprising retrieving (block 211) user related data 186. Specifically, user related data 186 is retrieved from user database 185 and is associated with first set of user devices 310. For example, user related data 186 may be retrieved by specific identification of first set of user devices 310 (e.g., IP address, user login, cookies, etc.). In these examples, interactive audio component 182 is generated based on user input 181 and user related data 186, which is retrieved from user database 185.

Some examples of user related data 186 include, but are not limited to, team choice (e.g., one of the teams participating in virtual event 101), one or more favorite players (e.g., participating or not participating in virtual event 101), favorite plays (e.g., long passes or running games in virtual football games), event, name, geographic location, second set of user devices 320 (e.g., related users/friends, blocked users), brand preferences, commercial transactions associated with virtual event 101, and the like. User related data 186 may be associated with user identification (e.g., a user name) or device identification. Some of user related data 186 may be available prior to the start of virtual event 101. Additional user related data 186 may be aggregated during virtual event 101, e.g., based on user input 181.

In some examples, method 200 further comprises retrieving event related data 188 from event database 187. Event related data 188 is associated with the set time in virtual event 101, i.e., the time when user input 181 was received by system 100. Some examples of event related data 188 include, but are not limited to, score, remaining time, current players, current play, number of fans, sponsors, and the like. In these examples, interactive audio component 182 is generated based on user input 181 and event related data 188.

Method 200 further comprises delivering (block 217) interactive audio component 182 to audio content integration module 165. In some embodiments, this operation is optional. In some examples, audio content integration module 165 and interactive audio component 182 are the same module.

Method 200 further comprises receiving (block 220) non-interactive audio content 163 from audio creation module 160. Non-interactive audio content 163 may be received by audio content integration module 165 or interactive audio module 180. Non-interactive audio content 163 is generated at audio creation module 160 and may include a combination of one or more of narration of virtual event 101, event sounds (e.g., helmet hits), and the like, as described above with reference to FIG. 1A. Non-interactive audio content 163 is an audio representation of virtual event 101 at a set time.

Method 200 further comprises combining (block 225) non-interactive audio content 163 and interactive audio component 182 thereby generating interactive audio content 183. Interactive audio content 183 is generated using audio content integration module 165. As schematically shown in FIG. 2B, interactive audio content 183 is a combination of non-interactive audio content 163 and interactive audio component 182. This operation may involve combining two audio streams into a single audio stream.

In some examples, various audio queues may be used for this operation to align, in time, non-interactive audio content 163 and interactive audio component 182. For example, non-interactive audio content 163 may comprises various sounds associated with a virtual football game, such as game commentary, field sounds, crowd sounds, and the like. Interactive audio component 182 may comprise cheer sounds associated with first set of user devices 310, such as voices of users interacting with first set of user devices 310. The cheer sounds of interactive audio component 182 may be delivered in real-time, near real-time, or aligned with a specific time in virtual event 101 (e.g., cheer at the end of successful play).

In some examples, various factors (e.g., relative sound levels) are used for generating interactive audio content 183. For example, with reference to FIG. 2C, non-interactive audio content 163 may have first sound level 291, while interactive audio component 182 may have second sound level 292. Second sound level 292 may be selected based on various characteristics of first set of user devices 310. For example, second sound level 292 may be selected to create the proximity perception for users of first set of user devices 310, e.g., as if these users are seated in the same section at the event and can hear each other better than the rest of event attendees. In these examples, interactive audio content 183 is generated based on first sound level 291 and second sound level 292.

In some examples, user input 181 comprises a user count, corresponding to a number of user devices in first set of user devices 310. Interactive audio component 182 may be a crowd sound (e.g., cheer), either supplied from first set of user devices 310 or from event database 187. First sound level 291 may be proportional to the user count. In other words, the sound level of the crowd sound is determined by the number of devices in first set of user devices 310.

In some examples, user input 181 comprises user audio content. For example, one or more users of first set of user devices 310 may speak into microphones of their devices. In these examples, generating interactive audio component 182 comprises selecting at least a portion of this user audio content. More specifically, in some embodiments, user audio content received from one or more user devices of the first set of user devices 310 may be incorporated into interactive audio component 182. In some embodiments, the entire user audio content is used as interactive audio component 182. Alternatively, one or more portions of the user audio content are not selected, e.g., to eliminate profanity or unrelated input, thereby improving the quality of interactive audio component 182.

In some examples, user input 181 comprises one or more social media posts associated with virtual event 101 such that interactive audio component 182 is generated based on the content of one or more social media posts in user input 181. More specifically, generating interactive audio component 182 comprises generating an audio representation of the one or more social media posts in user input 181. For example, text-to-speech software may be implemented to transform social media posts into audio that is incorporated into interactive audio component 182. As another example, OCR techniques may be implemented to recognize positive or negative associations or meanings in particular social media posts and retrieve virtual audio sounds (e.g., from event database 152) to incorporate into interactive audio component 182.

Interactive audio content 183 may then be transmitted to delivery module 170. This operation is performed by audio content integration module 165. Specifically, method 200 may further comprise transmitting (block 240) interactive audio content 183 to first set of user devices 310. This operation may be performed by delivery module 170 of system 100. The transmission of interactive audio content 183 to first set of user devices 310 is schematically illustrated in FIGS. 3A and 3B.

Briefly referring to FIG. 3A, interactive audio content 183 may be also transferred to second set of user devices 320, which are different from first set of user devices 310. For example, second set of user devices 320 may be identified based on some relation to first set of user devices 310, such as being fans of the same team, friends or contacts corresponding to the users of devices in first set of user devices 310, users from the same geographic location, and the like. Furthermore, as shown in FIG. 3A, third set of user devices 330 may receive non-interactive audio content 163. The association of third set of user devices 330 to first set of user devices 310 may be different from that of second set of user devices 320. For example, third set of user devices 330 may be fans of a different team.

In some examples, method 200 further comprises receiving additional user input 381 from second set of user devices 320 as, for example, schematically shown in FIGS. 3B and 3C. In these examples, the operation represented by block 210 and described above is repeated or performed simultaneously with additional user input 381. Second set of user devices 320 is different from first set of user devices 310. For example, users of second set of user devices 320 may be fans of one virtual team participating in virtual event 101, while users of first set of user devices 310 may be fans of another virtual team (e.g., the opposing team) participating in virtual event 101. In some examples, first set of user devices 310 may be positioned in a different geographic location from second set of user devices 320 or have other distinguishing characteristics. In yet another example, first set of user devices 310 and second set of user devices 320 may represent different parts of virtual stadium such that users of first set of user devices 310 may be able to more distinctively hear other users of first set of user devices 310 (e.g., when these other users provide user input 181) but not the users of second set of user devices 320, and vice versa.

Continuing with receiving additional user input 381, interactive audio component 182 may be generated based on based user input 181 and additional user input 381. Different factors or, more specifically, sound levels may be assigned to user input 181 and additional user input 381 when interactive audio component 182 is generated.

With reference to FIG. 2D, in some examples, additional user input 381 is used for generating additional interactive audio component 382 based on this additional user input 381. It should be noted that that in these examples, additional interactive audio component 382 is different from interactive audio component 182.

Method 200 may then involve combining, at audio content integration module 165, non-interactive audio content 163 and additional interactive audio component 382 thereby generating additional interactive audio content 383, different from interactive audio content 183. Additional interactive audio content 383 is then transmitted to delivery module 170 and eventually to user devices.

### Example Systems

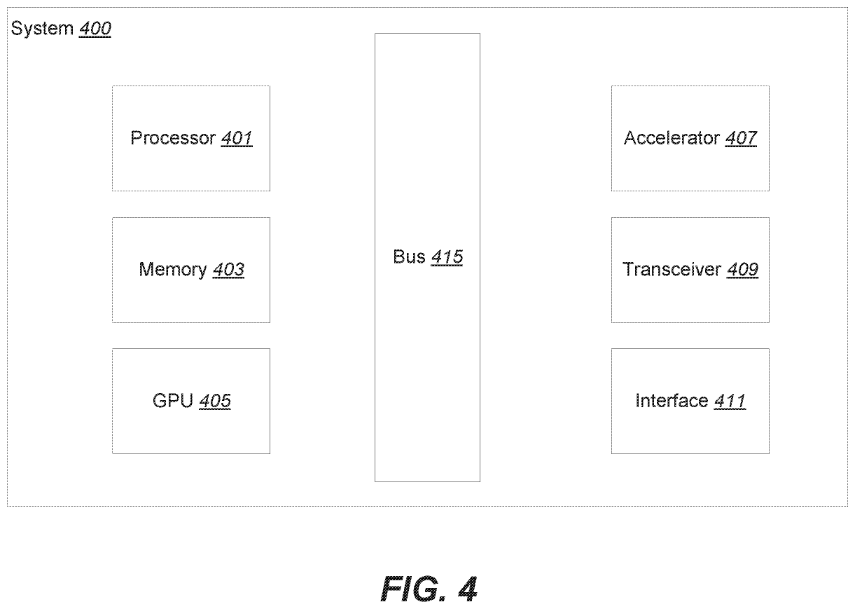

Various computing devices can implement the methods described herein. For instance, a mobile device, computer system, etc. can be used to generate dynamic ETA predictive updates. With reference to FIG. 4, shown is a particular example of a computer system 400 that can be used to implement particular examples of the present disclosure. According to particular example embodiments, a system 400 suitable for implementing particular embodiments of the present disclosure includes a processor 401, a memory 403, a transceiver 409, an interface 411, and a bus 415 (e.g., a PCI bus). For example, system 400 may represent one or more modules of system 100, such as audio creation module 160 or audio content integration module 165. As another example, system 400 may represent one or more user devices described herein. Various specially configured devices can also be used in place of a processor 401 or in addition to processor 401. The complete implementation can also be done in custom hardware.

The interface 411 is typically configured to send and receive data packets or data segments over a network. Particular examples of interfaces the device supports include Ethernet interfaces, frame relay interfaces, cable interfaces, DSL interfaces, token ring interfaces, and the like. The interface 411 may include separate input and output interfaces, or may be a unified interface supporting both operations. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

Transceiver 409 is typically a combination transmitter/receiver device. However system 400 may include a transmitter and a receiver as separate components in some embodiments. Transceiver 409 may be configured to transmit and/or receive various wireless signals, including Wi-Fi, Bluetooth, etc. In some embodiments, system 400 may function as a client device or location sensor or beacon to track location of an individual via wireless signals. The connection or communication between a client device and a beacon may indicate the presence of the corresponding individual in a particular location. In various embodiments, transceiver 409 may operate in a half duplex or full duplex mode. Various protocols could be used including various flavors of Bluetooth, Wi-Fi, light of sight transmission mechanisms, passive and active RFID signals, cellular data, mobile-satellite communications, as well as LPWAN, GPS, and other networking protocols. According to various embodiments, the transceiver may operate as a Bluetooth or Wi-Fi booster or repeater.

According to particular example embodiments, the system 400 uses memory 403 to store data and program instructions for operations including processing audio files. The program instructions may control the operation of an operating system and/or one or more applications, for example. The memory or memories may also be configured to store received metadata and batch requested metadata. The memory or memories may also be configured to store data corresponding to parameters and weighted factors.

In some embodiments, system 400 further comprises a graphics processing unit (GPU) 405. The GPU 405 may be implemented to process audio, video and images of original content data, as described herein. In some embodiments, system 400 further comprises an accelerator 407, In various embodiments, accelerator 407 is a rendering accelerator chip, which may be separate from the graphics processing unit. Accelerator 407 may be configured to speed up the processing for the overall system 400 by processing pixels in parallel to prevent overloading of the system 400. For example, in certain instances, ultra-high-definition images may be processed, which include many pixels, such as DCI 4K or UHD-1 resolution. In such instances, excess pixels may be more than can be processed on a standard GPU processor, such as GPU 405. In some embodiments, accelerator 407 may only be utilized when high system loads are anticipated or detected.

In some embodiments, accelerator 407 may be a hardware accelerator in a separate unit from the CPU, such as processor 401. Accelerator 407 may enable automatic parallelization capabilities in order to utilize multiple processors simultaneously in a shared memory multiprocessor machine. The core of accelerator 407 architecture may be a hybrid design employing fixed-function units where the operations are very well defined and programmable units where flexibility is needed. In various embodiments, accelerator 407 may be configured to accommodate higher performance and extensions in APIs, particularly OpenGL 2 and DX9.

Because such information and program instructions may be employed to implement the systems/methods described herein, the present disclosure relates to tangible, machine readable media that include program instructions, state information, etc, for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present examples are to be considered as illustrative and not restrictive.

What is claimed is:

1. A method for generating interactive audio content for a virtual event, the method comprising:
receiving, at an interactive audio module, user input from a first set of user devices;
generating, at the interactive audio module, an interactive audio component based on at least the user input;
delivering the interactive audio component to an audio content integration module;
receiving, at the audio content integration module, non-interactive audio content from an audio creation module, wherein the non-interactive audio content is an audio representation of the virtual event at a set time;
combining, at the audio content integration module, the non-interactive audio content and the interactive audio component, thereby generating the interactive audio content; and
transmitting, by the audio content integration module, the interactive audio content to a delivery module.

2. The method of claim 1, wherein:
the non-interactive audio content has a first sound level;
the interactive audio component has a second sound level; and
the interactive audio content is generated based on the first sound level of the non-interactive audio content and the second sound level of the interactive audio component.

3. The method of claim 2, wherein:
the user input comprises a user count corresponding the first set of user devices;
the interactive audio component is a crowd sound; and
the first sound level is proportional to the user count.

4. The method of claim 1, wherein:
the user input comprises a user audio content; and
generating the interactive audio component comprises selecting at least a portion of the user audio content in the user input.

5. The method of claim 1, wherein:
the user input comprises one or more social media posts associated with the virtual event; and
the interactive audio component is generated based on content of the one or more social media posts in the user input.

6. The method of claim 5, wherein generating the interactive audio component comprises generating an audio representation of the one or more social media posts in the user input.

7. The method of claim 1, wherein the user input comprises a commercial transaction completed by the first set of user devices and associated with the virtual event.

8. The method of claim 1, further comprising receiving, at the interactive audio module, additional user input from a second set of user devices, wherein the interactive audio component is generated based on the user input and the additional user input.

9. The method of claim 8, wherein the interactive audio content is transmitted to the first set of user devices and the second set of user devices.

10. The method of claim 1, further comprising:
receiving, at the interactive audio module, additional user input from a second set of user devices,
generating, at the interactive audio module, additional interactive audio component based on at least the additional user input;
combining, at the audio content integration module, the non-interactive audio content and the additional interactive audio component, thereby generating additional interactive audio content, wherein the additional interactive audio content is different from the interactive audio content; and
transmitting, by the audio content integration module, the additional interactive audio content to the delivery module.

11. The method of claim 10, wherein the interactive audio content and the additional interactive audio content are transmitted to different user devices.

12. The method of claim 1, further comprising retrieving, from a user database, user related data associated with the first set of user devices, wherein the interactive audio component is generated based on the user input and the user related data retrieved from the user database.

13. The method of claim 12, wherein the user related data comprises one or more of: team choice; commercial transactions, and identification of a second set of user devices.

14. The method of claim 1, further comprising retrieving, from an event database, event related data associated with the set time in the virtual event, wherein the interactive audio component is generated based on the user input and the event related data.

15. The method of claim 1, further comprising transmitting, by the delivery module, the interactive audio content to the first set of user devices.

16. The method of claim 15, further comprising transmitting, by the delivery module, the interactive audio content to a second set of user devices, different from first set of user devices.

17. The method of claim 16, further comprising transmitting, by the delivery module, the non-interactive audio content to a third set of user devices, different from first set of user devices and the second set of user devices.

18. The method of claim 1, wherein the virtual event is a virtual sporting event.

19. A non-transitory computer readable medium storing one or more programs configured for execution by a computer, the one or more programs comprising instructions for:
receiving; at an interactive audio module, user input from a first set of user devices;
generating, at the interactive audio module, an interactive audio component based on at least the user input;
delivering the interactive audio component to an audio content integration module;
receiving, at the audio content integration module, non-interactive audio content from an audio creation module, wherein the non-interactive audio content is an audio representation of the virtual event at a set time;
combining, at the audio content integration module, the non-interactive audio content and the interactive audio component, thereby generating the interactive audio content; and
transmitting, by the audio content integration module, the interactive audio content to a delivery module.

20. A system for generating interactive audio content for a virtual event, the system comprising:
an interactive audio module configured to:
receive user input from a first set of user devices; and
generate an interactive audio component based on at least the user input; and
an audio content integration module configured to:
receive the interactive audio component from the interactive audio module;
receive non-interactive audio content, wherein the non-interactive audio content is an audio representation of the virtual event at a set time;
combine the non-interactive audio content and the interactive audio component, thereby generating interactive audio content; and
transmit the interactive audio content.
